(19) United States
(12) Patent Application Publication
(10) Pub. No.: US 2009/0150581 A1
(43) Pub. Date: Jun. 11, 2009

(54) Method and system for providing data volumes

(76) Inventors: David Chimitt, Collegeville, PA (US); James Hunter, Chadds Ford, PA (US); Joseph P. Neill, E. Fallowfield, PA (US); Linh D. Nguyen, Philadelphia, PA (US); Tri T. Phung, Norristown, PA (US); Usha Srinivasan, Berwyn, PA (US)

Correspondence Address: UNISYS CORPORATION, UNISYS WAY, MAIL STATION: E8-114, BLUE BELL, PA, 19424, US

(21) Appl. No.: 10/706,345

(22) Filed: Nov. 12, 2003

(51) Int. Cl. G06F 3/00

(52) U.S. Cl. 710/74

(57) ABSTRACT

A method for processing input/output request packets (IRPs) directed to Data Volumes having a meta-data extent and at least one data extent begins by initiating an IRP. The IRP is evaluated by a volume filter to determine a meta-data extent to handle the IRP. The IRP is directed by the volume filter to the appropriate meta-data extent. The IRP is redirected from the meta-data extent to at least one data extent associated with the meta-data extent.

### FIELD OF INVENTION

The present invention relates generally to storage of digital information (i.e. data). More particularly, the present invention relates to storage of data using hosts running a Microsoft® Windows® type operating system or another operating system that is similar thereto.

### BACKGROUND

Microsoft® Windows® type operating systems, by way of example, include features called Basic Volume Managers and may also include Dynamic Volume Managers. Basic Volume Managers facilitate creation of Microsoft® Basic Volumes (hereinafter “Basic Volumes”). A Basic Volume is a particular portion of a magnetic disk that is designated for a particular user. For purposes of describing the present invention, a magnetic disk is defined as a memory device on which data is stored. A Basic Volume may be presented to its respective user as if it were a single disk on which the respective user may store data as desired.

Basic Volume Managers and thus Basic Volumes are limited in that a Basic Volume(s) may only be contained within a single disk or disk drive unit. For example, referring to FIGS. 1 and 2, a physical disk 10 is shown. In FIG. 1, a single Basic Volume is created such that it is the size of the entire physical disk 10. In FIG. 2, n Basic Volumes are created such that the size of each Basic Volume is 1/n GB. It should be noted that Basic Volumes do not have to be equally sized as shown in FIG. 2.

To provide additional functionality, certain Microsoft® Windows® type operating systems include a Dynamic Volume Manager. Dynamic Volume Managers facilitate creation of Dynamic Volumes. Dynamic Volumes may be contained within one or more disks thereby allowing volume size to be increased, as desired. Dynamic Volumes, however, are limited in that all the disks available to a Dynamic Volume are stamped with a unique signature. Stamping the disks with a unique signature does not allow the disks to be redundantly connected to a plurality of storage servers (i.e., simultaneously connected to a plurality of hosts).

It should be noted that although the shortcomings of the prior art are discussed, by way of example, in connection with Microsoft® Windows® type operating systems, the same type of shortcomings may apply to any type of operating system.

It is therefore desirable to provide a method and system so that a new type of data volumes, which we call “Data Volumes” may be provided without the limitations of the prior art.

### SUMMARY

The present invention is a method and system for providing inventive Data Volumes. These Data Volumes may be stored on one or more physical disks as may be desired, but appear and are presented to users as a single virtual disk. The physical disks may be redundantly connected to one or more storage servers or hosts.

### BRIEF DESCRIPTION OF THE DRAWING(S)

FIG. 1 is a conventional Basic Volume stored on a single physical disk.

FIG. 2 is a plurality of conventional Basic Volumes stored on a single physical disk.

FIG. 3 is a system where Data Volumes may be provided across multiple disks and redundantly connected to multiple hosts in accordance with the present invention.

FIG. 4 is a simple Data Volume on a single physical disk in accordance with the present invention.

FIG. 5 is two simple volumes located on a single physical disk in accordance with the present invention.

FIG. 6 is two simple volumes located on a single physical disk wherein one volume is an extended simple volume in accordance with the present invention.

FIG. 7 is a spanned volume wherein the volume spans two physical disks in accordance with the present invention.

FIG. 8 is a spanned volume wherein exemplary sizes for meta-data extents and data extents are shown.

FIG. 9 is diagram illustrating the process of redirecting an I/O request packet (IRP) from a meta-data extent to an appropriate data extent in accordance with the present invention.

FIG. 10 is a diagram illustrating the process of redirecting an IRP from a meta-data extent to appropriate data extents in accordance with the present invention.

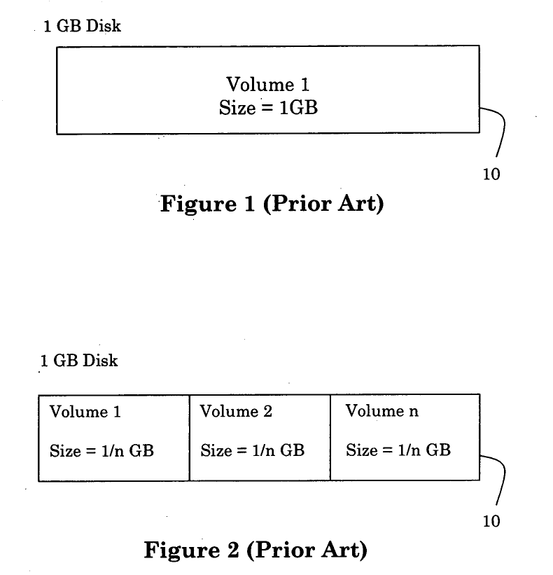

### DETAILED DESCRIPTION OF THE PREFERRED EMBODIMENT(S)

For purposes of describing the present invention, the term host is defined as a computer through which another computer can access data and/or programs by means of a network, modem, wireless connection or any other means of sharing data and/or programs between computers. The terms host and storage server may be used interchangeably as desired. It should be noted that the host(s) described herein are preferably running a Microsoft® Windows® type operating system, but the present invention may be implemented in a system running any type of operating system, as desired. Furthermore, the terms block and sector may be used interchangeably herein.

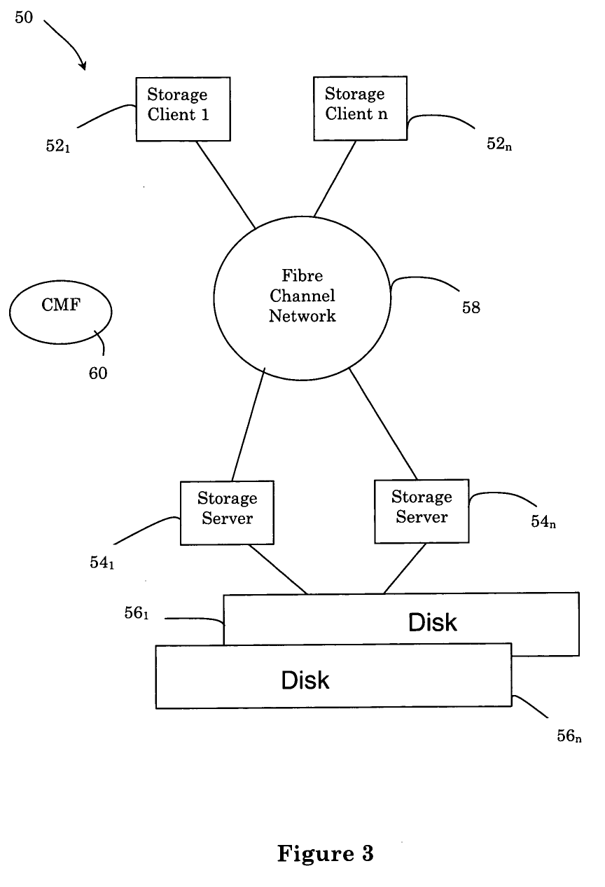

Referring initially to FIG. 3, there is shown a system 50 for providing users with redundant Data Volumes, as desired. In one embodiment, the system 50 includes a plurality of storage clients 52₁ . . . 52ₙ that may access data residing on disks 56₁ . . . 56ₙ The data residing on disks 56₁ . . . 56ₙ may be accessed by storage clients 52₁ . . . 52ₙ through storage servers 54₁ . . . 54ₙ. The storage servers 54₁ . . . 54ₙ and storage clients 52₁ . . . 52ₙ are connected across a network such as, for example, a fibre channel network 58.

The storage servers 54₁ . . . 54ₙ may be controlled using a distributed computing interface at a central management facility (CMF) 60. The CMF 60 includes a computer through which a system administrator can control the storage servers, as desired. The CMF is typically located remotely with respect to storage servers 54₁ . . . 54ₙ and can access the storage servers 54₁ . . . 54ₙ, as desired, over any type of wired or wireless connection.

The Data Volumes created pursuant to the present invention are, in one embodiment, composed of logical drives. Logical drives are features of Basic Volumes created in Microsoft® Windows® type operating systems, but Data Volumes may be composed of any type of logical drives, as desired. Each Data Volume includes at least two logical drives (hereinafter referred to as extents): a meta-data extent and at least one data extent. The meta-data extent includes the configuration information necessary to set up and maintain the Data Volumes. By keeping the meta-data on disk, the configuration information persists across reboots and migration across homogenous systems.

The present invention is preferably implemented in a Microsoft® Windows® type operating system above Basic Volumes. Implementing the present invention above Basic Volumes enhances the feature set of Basic Volumes so that simple, spanned, or extended simple volumes may be provided, as explained below, in the form of Data Volumes. In the preferred embodiment, Data Volumes are associated with at least two Basic Volumes. That is, a Data Volume of the present invention preferably includes one Basic Volume associated with a meta-data extent and one Basic Volume associated with each data extent. Therefore, in the present invention, it can be said that at least two Basic Volumes are logically combined to make a single Data Volume and that each extent, whether a data extent or meta-data extent, is preferably a separate Basic Volume. With respect to this association, it is important to note that logical drives are considered a type of Basic Volume.

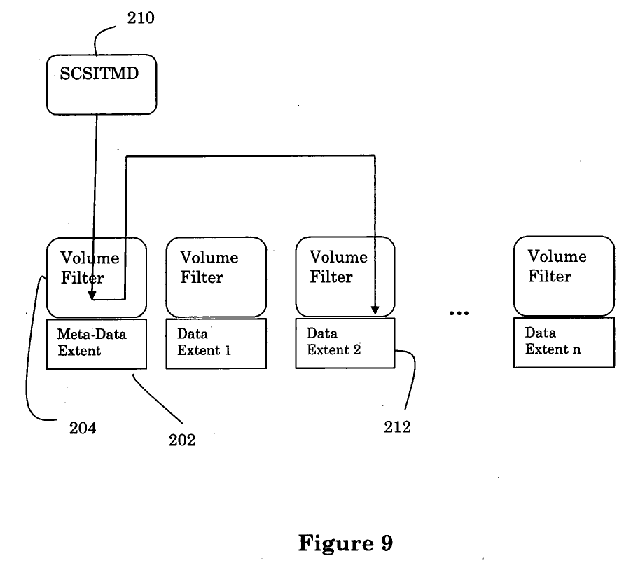

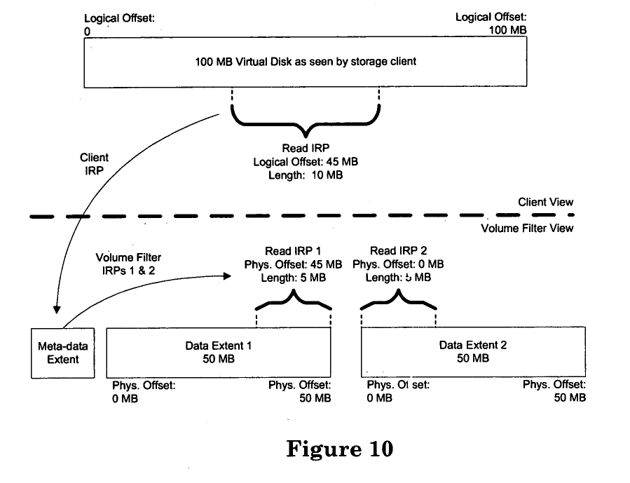

As mentioned above, the present invention is preferably implemented above Basic Volumes in a Microsoft® Windows®& type operating system. To implement the present invention above Basic Volumes, the Basic Volumes are logically combined across physical disks and presented to users as a single Data Volume. To logically combine Basic Volumes into a single Data Volume, one Basic Volume is preferably associated with a meta-data extent that includes information regarding the data extents making up the Data Volume. I/O request packets (IRPs) directed to particular Basic Volumes by the operating system are intercepted using a volume filter and redirected according to the logic of a particular Data Volume. The volume filter is considered above Basic Volumes in that IRPs bound for the hardware are intercepted and processed by the volume filter before they have had a chance to be processed by the Basic Volume Manager. To intercept the IRPs, the volume filter driver is preferably built and installed according to the Microsoft® Windows® Driver Model wherein the system, via an I/O manger for example, knows to send IRPs to upper level filters first. Once the volume filter receives the IRP, the volume filter can send the IRP along its expected path (i.e. down to a Basic Volume) or redirect it as appropriate. For example, bearing in mind that in the present invention Basic Volumes correspond to extents, IRPs directed to a meta-data extent are typically redirected by the volume filter to an appropriate data extent where they are allowed to pass through the volume filter down to the data extent. An example of this process is provided in FIGS. 9 and 10.

It is important to note that the volume filter preferably is software written specifically to implement the present invention i.e., logically combine Basic Volumes, referred to as extents, so that any number of Basic Volumes possibly located on separate disks may appear and be presented to users as a single Data Volume, as explained herein. As mentioned, the volume filter is conceptually above the Basic Volumes so that IRPs are processed by the volume filter prior to being processed by the Basic Volume Manager. The volume filter is incorporated into the operating system and only the I/O manager is aware that it is there. That is, I/O originators think they are talking to a single Basic Volume and are not aware that their I/O may be redirected according to the logic of a particular Data Volume.

With respect to the extents, from a physical standpoint, the extents are simply space on physical disks wherein data may or may not exist, as desired. From a logical standpoint, the extents are the components that make up a Data Volume wherein the existing functionality of Microsoft® Windows® type operating systems are utilized so that each component is simply operating exactly like a Basic Volume does to the Microsoft® Windows® type operating system instance in which it functions.

The Data Volumes may be configured, as desired, as simple, spanned, or extended simple volumes or any combination thereof. Simple volumes include a meta-data extent and at least one data extent. In the case of simple volumes, the meta-data is located on the same disk as the data extent. Spanned volumes include multiple data extents on multiple disks. The meta-data extent for a spanned volume need not reside on a disk containing a data extent.

Both types of volumes, simple and spanned, may be extended by appending additional extents to the end of a volume. If an additional extent is appended to a simple volume and the additional extent is located on the same disk as the original extent, that volume is now considered an extended simple volume. If the additional extent is added to a disk other than that which contains the first data extent, that volume is now considered a spanned volume. The meta-data extent includes information necessary to link together a meta-data extent with its respective volume and its respective data extents, regardless of whether the volume is a simple, spanned, or extended volume.

Users having operating systems configured with the features of the present invention may set up (or have set up for them) Data Volumes based on their individual needs. That is, users are provided with a Data Volume having a meta-data extent and whatever number of data extents they want. If, subsequent to Data Volume set up, a user needs additional storage space, the storage capacity of the user's Data Volume may be increased by adding additional data extents and updating the meta-data extent accordingly.

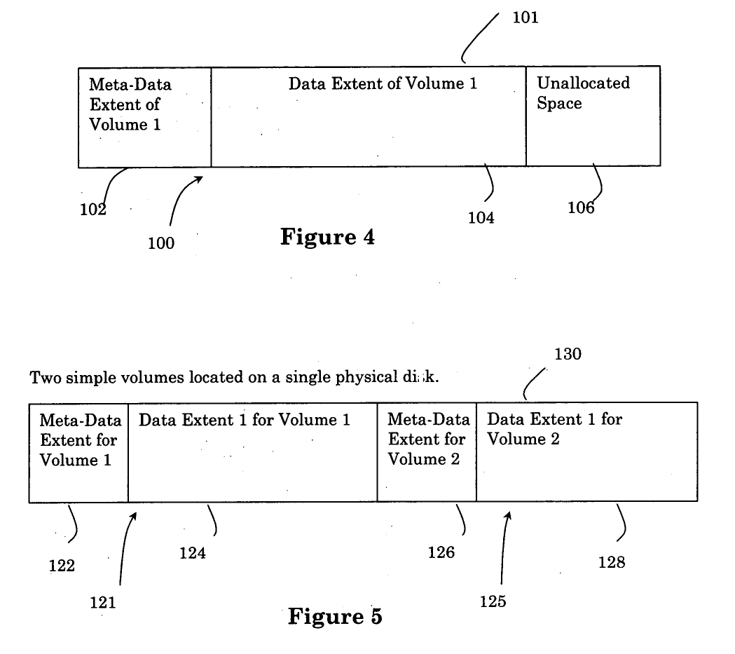

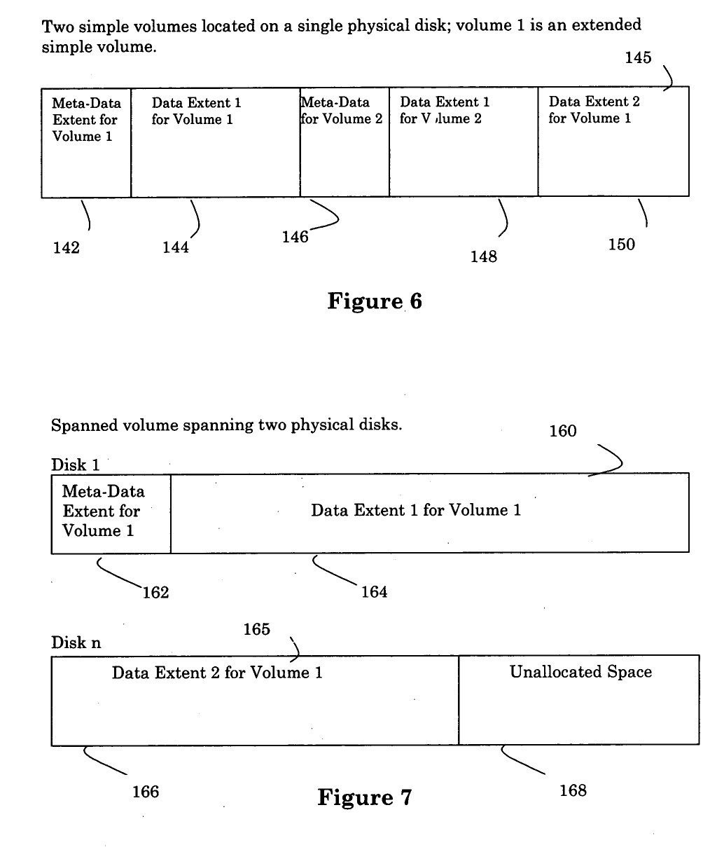

By way of example, possible configurations of Data Volumes are shown in FIGS. 4-8. Referring initially to FIG. 4, a simple volume 100 is shown on a single physical disk 101. Simple volumes include a meta-data extent 102 and a data extent 104. Depending on the size of the data extent, there may also be currently unallocated space 106. In FIG. 5, two volumes 121, 125 are located on a single physical disk 130. In this configuration, there are two meta-data extents 122, 126 and two data extents 124, 128. In FIG. 6, an extended simple volume located on a single physical disk 145 is shown. The extended simple volume includes meta-data extent 142, and data extents 144 and 150. The use of two data extents 144, 150 is purely operator preference and may be done, for example, where the amount of disk space originally allocated to volume 1 was not sufficient.

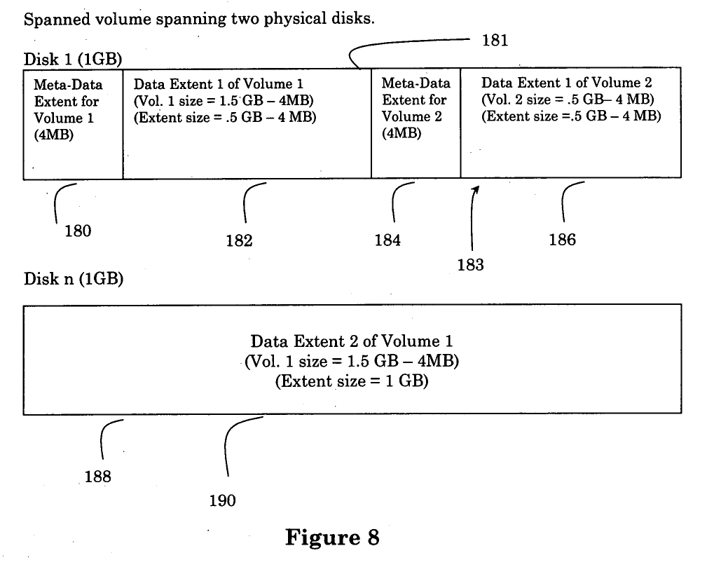

Referring now to FIGS. 7 and 8 in particular, volumes may be located across physical disks as desired. Furthermore, the data extents that make up a particular Data Volume may be any size and be located across any number of physical disks. In FIG. 7, for example, volume 1 includes two data extents. One data extent 164 is located on a first disk (i.e. disk 1) 160 while the other data extent 166 is located on disk n 165. In FIG. 8, a similar arrangement is shown except in FIG. 8 there is second volume 183 on disk 1 181.

Also shown in FIG. 8 is an embodiment illustrating, purely by way of example, approximate sizes of the various meta-data and data extents provided across disk 1 181 and disk n 190. Volume 1 includes a meta-data extent 180, a first data extent 182, and a second data extent 188. The meta-data extent 180 and data extent 182 are located on disk 1 181 along with volume 2 183 which includes meta-data extent 184 and data extent 186. In this embodiment, disk 1 181 and disk n 190 are 1 GB disks wherein the disk space of disk 1 181 is distributed evenly between the portion of volume 1180, 182 that is on disk 1 181 and volume 2 183. While the meta-data extents may be any size, in this embodiment they are approximately 4 MB. Therefore, the size of data extent 182 is 0.5 GB-4 MB. Similarly, the size of data extent 186 is also 0.5 GB-4 MB.

The remaining portion of volume 1 is contained in data extent 2 188 of volume 1 which is located on disk n 190. Of course, additional extents for volumes 1 and 2 as well additional volumes may be created using additional disks, as desired.

A meta-data extent, in one embodiment, may include two regions, a meta-data header region and a volume filter region. The volume filter region includes data describing up to, in one embodiment, 1024 data extents which comprise a simple, extended, or spanned volume. Below is a table (table 1) illustrating, purely by way of example, the information that may be provided in a meta-data header region. This information may vary as desired.

TABLE 1

| | Size | Byte | |
|---|---|---|---|
| Field Description | (bytes) | Offset | Example |
| Unisys Metadata Tag | 16 | 0 | UNISYS_MD_HEADER |
| Unisys Metadata GUID | 16 | 16 | {...} |
| Version | 8 | 32 | v.01.000 |
| Reserved | 472 | 40 | |

In the column entitled Field Description in table 1 shown above, the Unisys Meta-data Tag is an American Standard Code for Information Interchange (ASCII) tag identifying the extent as a meta-data extent. The Unisys Meta-data GUID is a globally unique identifier (GUID), in binary, that identifies the extent as a meta-data extent. The Version specifies the current version of the meta-data header. The current version is specified to enable software accessing the meta-data to confirm that it is accessing meta-data defined in a manner consistent with the software's expectations. This is often referred to as a “handshake” between software applications to be sure that both applications are speaking the same language. The “Reserved” field provides information on space that is reserved for future use.

Below is a table (table 2) illustrating, purely by way of example, the information that may be provided in a volume filter region. This information may vary as desired.

TABLE 2

| | Size | Byte | |
|---|---|---|---|
| Field Description | (bytes) | Offset | Sample |
| Volume Filter Metadata | 16 | 0 | UNISYS_BVF_MDTAG |
| TAG | | | |
| Volume Filter Metadata | 16 | 16 | {...} |
| GUID | | | |
| Version | 8 | 32 | v.01.100 |
| Volume Length (Blocks) | 8 | 40 | 208782 |
| # of Extents | 4 | 48 | 2 |
| Meta-data Extent Name | 256 | 52 | /??/Storage... |
| Meta-data Extent Disk | 64 | 308 | |
| Serial Num | | | |
| Meta-data Length | 8 | 372 | 16002 |
| (Blocks) | | | |
| Meta-data Flags | 8 | 380 | NULL |
| Extent 1 Name | 256 | 388 | /??/Storage... |
| Extent 1 Disk Serial | 64 | 644 | |
| Num | | | |
| Extent 1 Length (Blocks) | 8 | 708 | 208782 |
| Extent 1 Flags | 8 | 716 | NULL |
| | 343392 | 724 | |
| Extent 1024 Name | 256 | 344116 | NULL |
| Extent 1024 Disk Serial | 64 | 344372 | NULL |
| Num | | | |
| Extent 1024 Length | 8 | 344436 | NULL |
| (Blocks) | | | |
| Extent 1024 Flags | 8 | 344444 | NULL |
| Reserved | 179836 | 344452 | |

In the column entitled Field Description in table 2 shown above, the Volume Filter Meta-Data Tag is an ASCII tag identifying the region as the volume filter meta-data region. The Meta-Data GUID is again in binary and identifies the volume filter meta-data region. The Version specifies the current version of the volume filter meta-data region. The Volume Length is the length of volume in blocks not including the meta-data extent. This value is preferably derived from adding together the lengths of all of the data extents that make up this volume. The Number of Extents is the total number of extents that make up this volume including the meta-data extents. The Extent Name is the persistent name of the extent which, as noted above, persists across reboots and migration to other Windows® systems. The Extent Disk Serial Number is the serial number of the disk on which the extent is located. The Extent Length is the length of the extent in blocks. The Extent Flags is space reserved for each extent that can be used for any reason. Reserved is space reserved for future implementation.

The volume filter region preferably links together all the extents that make up a simple, extended, or spanned volume. The data extents are listed in logical address order. A logical address is the volume offset as perceived by the client. For example, consider a spanned volume with 2 extents each 50 blocks large. Extent 1 of the volume filter meta-data may be configured to handle input/output (I/O) for logical block offsets 0-49 while extent 2 will handle I/O sent to blocks 50-99. This ordering of extents, once established, is preferably not compromised.

Once storage volumes are created, they are eligible for virtualization (i.e., presentation to users as a single disk). Virtualization of volumes requires that the volume name be passed to a driver adapted to virtualize volumes to clients, such as a Small Computer System Interface Target Mode Driver (SCSITMD). The volume name that is passed in is preferably the name of the meta-data extent. Furthermore, the size that is passed in is preferably the accumulated size of all the affiliated data extents. It is important to note that the multi-extent composition of Data Volumes is visible only to the volume filter driver.

As a virtualization example, consider a 1 GB volume consisting of a 4 MB meta-data extent and any combination of data extents with a combined size of 1 GB. CMF presents this volume to SCSITMD for virtualization by passing in the name of the meta-data extent. Once virtualized, all I/O sent through SCSITMD to a particular volume is targeted exclusively at that volume's meta-data extent. It is the responsibility of a volume filter located above the meta-data extent to redirect the I/O to the appropriate data extent(s). The filters above data extents allow I/O request packets (IRPs) to pass through untouched. These filters are considered “pass through” filters.

To provide an example of how the virtualization process may be implemented, in one embodiment, reference is now made to FIG. 9. This embodiment is preferably implemented in a Microsoft® Windows® type operating system above Basic Volumes. First, the SCSITMD 210 or, any originator of I/O, forwards client IRP(s) to a meta-data extent 202 which are intercepted by the meta-data extent's volume filter 204. Next, the volume filter 204 creates additional IRP(s) for each data extent affected by the original IRP(s). The additional IRP(s) are then sent to the appropriate data extents and offsets within the various extents. The volume filter for each data extent (in this case data extent 212) allows the additional IRP(s) to pass through untouched.

To further illustrate this process, reference is made to FIG. 10. In FIG. 10, a client IRP is generated and sent to the meta-data extent associated with the data extent(s) affected by the IRP. In the example shown, the IRP involves a read which is 10 MB in length with a logical offset of 45 MB. In this case, the IRP affects two data extents (i.e. data extent 1 and data extent 2). Therefore, the original IRP is broken into two IRPs (IRP 1 and IRP 2). Then, the IRPs are sent to the appropriate locations of each data extent taking into account the offset which, as shown, may be considered virtual with respect to the client and physical with respect the volume filter. It should be noted that data extent 1 and data extent 2 may or may not be located on a single physical disk, as explained above.

The present invention enables Data Volumes to be created, deleted, and expanded, as desired, as explained above thereby enhancing the feature set of Microsoft® Windows® Basic Volumes when implemented in conjunction therewith. Data Volume creation involves the linking of one meta-data extent and at least one data extent into a Data Volume. As mentioned, in one embodiment, each extent is preferably a logical drive (i.e. a Basic Volume) in an extended Basic partition of a Microsoft® Windows® type operating system. New Data Volumes may be created in response to user level requests, via an exposed Data Volume interface. The appropriate extents are preferably created prior to the request submission and by an entity other than a Data Volume driver. These extents are then passed down to the Data Volume driver along with the creation request. The first extent listed is preferably the meta-data extent. Creation of additional Data Volumes involves the following actions:
1. Allocate the appropriate data structures representing each of the data extents. These structures are then linked together into another data structure representing the new Data Volume. This structure is added to the global Data Volume list.
2. Write the persistent Data Volume information to the meta-data extent.
3. Tag the meta-Data Volume filter device as a meta-data extent. This enables I/O redirection for this filter device.

When a Data Volume is deleted it is preferably removed from a global list of all the currently existing volumes. All memory allocated for structures representing the deleted volume are preferably freed. Volume expansion occurs upon a user mode request to expand an existing Data Volume. A Data Volume is expanded by appending one or more additional data extents to an existing Data Volume. In a preferred embodiment, additional data extents are created prior to initiation of an expansion request. Volume expansion involves updating the meta-data and extent information on the meta-data extent and updating the global meta-data information for the currently existing Data Volumes.

System discovery and recreation of new and/or existing Data Volumes may occur during system reboots. That is, the persistence of each Data Volume's meta-data extent gives the Data Volume driver the capability to discover and recreate Data Volumes during system reboots. During system start, in one embodiment, the system examines each Data Volume to determine if it is a meta-data extent. When a meta-data extent comes on-line, the Data Volume driver extracts from the meta-data the data extent(s) that comprise the Data Volume, even if some or all of the data extents are off-line. When all the data extents have come on-line, client I/O redirection, as described in conjunction with FIGS. 9 and 10, is enabled.

The process for Data Volume discovery and recreation may be, purely by way of example, implemented in the following steps:
1. Read the extent's first sector, looking for the meta-data GUID and version number (i.e., validate the header region)
2. If the GUID and version number indicate that the extent is a valid meta-data extent, validate the meta-data region and, if validated, the remaining sectors may be read as it is assumed that the rest of the data is in the expected structure. This information is stored in local memory, even if some or all of the data extents are not yet on-line.
3. Register for Plug and Play notification for arrival of new extents. In doing so, a call back routine is provided, called a notification routine, that will be called by the Plug and Play Manager, when new extents arrive. The notification routine will be given the name of the new extent that was just registered. (Note: The notification routine will be called for each extent that was enumerated prior to registration as well.)
4. The notification routine will be given the name of the new extent that was just registered. That name is compared with the names of the data extents contained in the Data Volume. If a match is found, that extent may be opened for I/O.

CMF preferably is also capable of discovering Data Volumes created pursuant to the present invention. Therefore, in one embodiment, upon system start CMF compiles a list of Data Volumes that are on the system and eligible for virtualization. To accomplish this, CMF preferably launches a discovery process to identify all volumes located on the system. A potential consequence of this is that the discovery process will discover and report every extent (i.e. meta-data and data) for each Data Volume as an independent volume eligible for virtualization. To avoid this, a preferred embodiment of the present invention is to hide all data extents and set up each meta-data extent as the sole representative of their respective volume.

The data extents are hidden in one embodiment by disabling the data extent's interface to the volume class, effectively hiding the extent from CMF discovery. By way of explanation, volume class refers to a class of devices which particular software applications may wish to interface with. Therefore, if a driver represents one or more volume devices (or data extents), the driver will register with the volume class and enable an instance of the volume for each such device (or in this case data extent). In a preferred embodiment, software applications making inquiries as to which extents exist on the system will not be informed of the extents whose interface instances were disabled, thereby hiding them from the system.

It should be noted that it is possible that a disk containing a valid data extent for a Data Volume is removed and reinserted. Disk removals are handled via Plug and Play Notification. Just as the addition of a new extent generates a device interface arrival notification, the removal of a disk causes a device interface removal notification for each extent located on that disk.

In one embodiment, when a meta-data extent is notified of the removal of another extent, it examines its list of data extents to determine if the extent is its own. If it is, the meta-data extent invalidates the missing extent and sends a Windows® Management Instrumentation (WMI) event alerting user mode of the absence. In such a scenario, I/O may continue to be sent to other extents. If the meta-data extent is removed, the entire volume is disabled until, of course, the extent comes back on line.

Reinsertion of disks generates an additional device interface arrival notification for each extent on the disk. The reinserted data extent's meta-data extent rebuilds the data extent information and re-enables I/O to its respective data extent(s). The arrival of meta-data extents involves the rebuilding of the meta-data extent entry and the re-enabling of the entire Data Volume.

It should be noted that the present invention may be implemented in a variety of computer systems and that the various techniques described herein may be implemented in hardware or software, or a combination of both. Furthermore, while the present invention has been described in terms of various embodiments, other variations, which are within the scope of the invention as outlined in the claims below will be apparent to those skilled in the art.

1. A method for processing input/output request packets (IRPs) directed to a Data Volume for providing a single logical storage device to users and applications of a computing system, the Data Volume having a meta-data extent and at least one data extent, wherein the meta-data extent and at least one data extent are Basic Volumes, and the method is implemented above a Basic Volume Manager, the method comprising the steps of:
intercepting an initial IRP before the IRP reaches a file system associated with the IRP;
evaluating the IRP by a first volume filter associated with the meta-data extent to determine the meta-data extent to handle the IRP;
directing the IRP by the first volume filter to the appropriate meta-data extent;
redirecting the IRP from the meta-data extent to a second volume filter associated with the at least one data extent associated with the meta-data extent;
returning a response to the initial IRP from the second volume filter associated with the at least one data extent;
wherein the meta-data extent is a first logical drive and the at least one data extent is a second logical drive;
the Data Volume appears as a single storage volume to the users and the applications; and
the meta-data extent comprises configuration information for use in setting up and maintaining the Data Volumes.

2. The method of claim 1 wherein the IRP is initiated by an originator of input/output (I/O).

3. The method of claim 2 wherein the originator of I/O is a Small Computer System Interface Target Mode Driver (SCSITMD).

4. The method of claim 1 wherein the meta-data extent is associated with a plurality of data extents.

5. The method of claim 4 wherein the plurality of data extents are located on a plurality of physical disks.

6. (canceled)

7. The method of claim 1 wherein the redirecting step includes creating additional IRPs by the volume filter, each additional IRP being derived from the initiated IRP and relating to a single data extent.

8. (canceled)

9. A method for storing data across at least one physical disk and presenting the data as a single virtual disk comprising the steps of:
intercepting a first input/output request packet (IRP) from an originator of I/O before the IRP reaches a file system associated with the IRP;
forwarding the first IRP to a first volume filter associated with the meta-data extent;
creating an additional IRP by the first volume filter for each data extent affected by the first IRP;
transmitting each additional IRP to a second volume filter associated with each data extent affected by the first IRP;
allowing each additional IRP to pass through the second volume filter associated with volume filter of each data extent affected by the first IRP; and
returning a response to the first IRP from each second volume filter associated with the at least one data extent originator of I/O.

10. (canceled)

11. The method of claim 9 wherein the data extents are located on separate physical disks.

12. The method of claim 9 wherein the data extents affected by the first IRP are located on separate physical disks.

13. (canceled)

14. A computer system for providing a single Data Volume of data storage to users and applications of the computing system, the system comprising:
a plurality of storage clients connected to at least one storage server across a computer network;
a plurality of magnetic disks wherein Data Volumes may be created and virtually presented to said storage clients, each of said Data Volumes having a meta-data extent and at least one data extent, the meta-data extent including a first volume filter adapted to intercept and redirect input/output request packets (IRPs) received from one of the storage clients, before the IRP is received by an associated file system, to a second volume filter associated with the at least one data extent, said first volume filter configured to create an additional IRP for each data extent affected by the IRP; the second volume filter associated with each of the at least one data extent returns a response to the IRP, and wherein the first and second volume filters are implemented above a Basic Volume Manager; and
a central management facility for controlling the at least one storage server;
wherein the meta-data extent is a first logical drive and the at least one data extent is a second logical drive;
the Data Volume appears as a single storage volume to the users and the applications; and
the meta-data extent comprises configuration information for use in setting up and maintaining the Data Volume.

15. The computer system of claim 14 wherein the computer network is a fibre channel network.

16. The computer system of claim 14 wherein each storage client is presented with a virtual disk including at least one Data Volume having a meta-data extent and at least one data extent.

17. (canceled)

18. The computer system of claim 14 wherein the at least one data extent is a plurality of data extents and the IRPs are redirected to the data extents based on which data extents are affected by the IRPs.

19. The computer system of claim 14 wherein each storage client is presented with a particular Data Volume including a meta-data extent and at least one data extent.

20. The computer system of claim 19 wherein the Data Volume is a simple volume.

21. The computer system of claim 19 wherein the Data Volume is a spanned volume.

22. The computer system of claim 21 wherein the Data Volume includes at least three Basic Volumes and a volume filter is logically disposed above said Basic Volumes.

23. A volume filter for redirecting input/output request packets (IRPs) sent from an input/output (I/O) originator, the volume filter comprising:
intercepting means for intercepting IRPs sent to a meta-data extent associated with a Basic Volume before the IRP is received by an associated file system;
evaluating means for evaluating IRPs to determine a meta-data extent to handle the IRP;
redirecting means for redirecting the IRPs to at least one data extent associated with at least one other Basic Volume wherein a plurality of data extents are associated with an equal number of Basic Volumes; and
creating means for creating an additional IRP for each data extent affected by a redirected IRP;
wherein the meta-data extent is a first logical drive and the at least one data extent is a second logical drive;
the Data Volume appears as a single storage volume to the users and the applications; and
the meta-data extent comprises configuration information for use in setting up and maintaining the Data Volume.

24. The volume filter of claim 23 wherein the plurality of data extents includes data extents located on separate physical disks.

25. The volume filter of claim 24 wherein the volume filter is logically disposed above the Basic Volumes.
